(19) United States
(12) Patent Application Publication
(10) Pub. No.: US 2012/0227307 A1
(43) Pub. Date: Sep. 13, 2012

(54) ILLUMINATED FISHING POLE

(76) Inventors: Carlos Cuevas, Rockford, IL (US); Khley Lach, Chicago, IL (US)

(21) Appl. No.: 13/046,736

(22) Filed: Mar. 12, 2011

(51) Int. Cl. A01K 87/00; A01K 99/00

(52) U.S. Cl. 43/17.5; 43/18.1 R

(57) ABSTRACT

In one embodiment of the invention, an illuminated fishing pole includes: a shaft; a light emitting diode (LED) disposed within the shaft; a battery compartment coupled to the shaft; and an optical path configured to transmit light from the LED.

### TECHNICAL FIELD

Embodiments of the invention relate generally to illuminated fishing poles.

### BACKGROUND

People who fish often encounter poor lighting conditions. For example, some people fish during dark conditions because some fish species are most active in their feeding during nighttime or between sunset and sunrise. Under poor lighting conditions, it may be difficult for the fisherman (or fishing-woman) to see the movement of the fishing pole tip when a fish strikes a hook on a line that is guided by the pole, to see when the line becomes tangled, and/or to see an entanglement of the line.

Illuminators or lightings for current fishing poles are commercially available from various vendors. For example, glowing sticks can be added to bobbers or to the tip of a fishing pole. However, these glowing sticks can separate from the fishing pole and fly away during the casting of the fishing pole.

A phosphorescent spray can also be used to provide a glow-in-the-dark fishing pole tip. However, the glow of the spray can last only a short time (e.g., approximately ten minutes or less) and requires recharging of the pole tip.

Bells have also been attached to a fishing pole tip in order to alert the fisherman of a fish strike. However, bells can also separate from the fishing pole and fly away during the casting of the fishing pole. Additionally, bells may be annoying to the fisherman and may also frighten away a feeding fish.

Based on the above discussion, the current technology is limited in its capabilities and suffers from at least the above constraints and deficiencies.

### SUMMARY

In one embodiment of the invention, an illuminated fishing pole includes: a shaft; a light emitting diode (LED) disposed within the shaft; a battery compartment coupled to the shaft; and an optical path configured to transmit light from the LED.

In another embodiment of the invention, an illuminated fishing pole, includes: means for emitting a light within the fishing pole; and means for transmitting the light from the means for emitting the light.

In another embodiment of the invention, a method of assembling an illuminated fishing pole includes: providing a light emitting diode within the fishing pole, providing a battery compartment within the fishing pole, and providing an optical path for transmitting the light from the light emitting diode.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a cross-sectional view of an illuminated fishing pole, in accordance with an embodiment of the invention.

FIG. 2 is a cross-sectional view of a battery compartment in the illuminated fishing pole, in accordance with an embodiment of the invention.

FIG. 3 is a cross-sectional view of the lower portion of the forward rod section and the upper portion of the rearward rod section, in accordance with an embodiment of the invention.

### DETAILED DESCRIPTION OF PREFERRED EMBODIMENTS

In the description herein, numerous specific details are provided, such as examples of components, parts, structures, and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, structures, and/or the like. In other instances, well-known structures, materials, or operations are not shown or described in detail to avoid obscuring aspects of embodiments of the invention. Additionally, the figures are representative in nature and their shapes are not intended to illustrate the precise shape or precise size of any element and are not intended to limit the scope of the invention.

Those skilled in the art will understand that when an element or part in the drawings is referred to as being “on” (or “connected” to or “coupled” to or “attached” to) another element, it can be directly on (or attached to) the other element or intervening elements may also be present. Furthermore, relative terms such as “inner”, “outer”, “upper”, “above”, “lower”, “beneath”, and “below”, and similar terms, may be used herein to describe a relationship of one element or another element. It is understood that these terms are intended to encompass different orientations of the device in addition to the orientation depicted in the figures.

Although the terms first, second, and the like may be used herein to describe various elements, components, parts, regions, layers and/or sections, these elements, components, parts, regions, layers, chambers, and/or sections should not be limited by these terms. These terms are only used to distinguish one element, component, part, region, layer, chamber, or section from another element, component, part, region, layer, chamber, or section. Thus, a first element, component, part, region, layer, chamber, or section discussed below could be termed a second element, component, part region, layer, chamber, or section without departing from the teachings of the present invention.

Embodiments of the invention are described herein with reference to cross-sectional view illustrations that are schematic illustrations of representative embodiments of the invention. As such, variations from the shapes of the illustrations as a result of, for example, manufacturing techniques and/or tolerances are expected. For purposes of avoiding in overcrowding the drawings, the elements shown in the drawings are not necessarily drawn to scale, and the elements may be larger in physical size or smaller in physical size than as shown in the drawings.

Embodiments of the invention should not be construed as limited to the particular shapes of the regions or components/parts/elements illustrated herein but are to include deviations in shapes that result, for example, from manufacturing or particular implementations. For example, an element illustrated or described as square or rectangular may typically have rounded or curved features due to normal manufacturing tolerances or due to a particular implementation. Thus, the elements illustrated in the figures are schematic in nature and their shapes are not intended to illustrate the precise shape of an element of a device and are not intended to limit the scope of the invention.

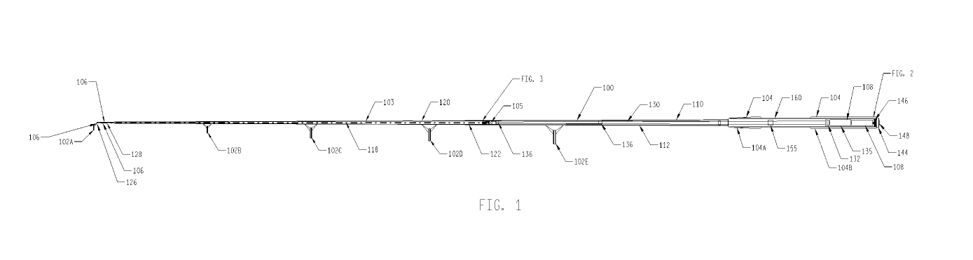

FIG. 1 is a cross-sectional view of an illuminated fishing pole 100, in accordance with an embodiment of the invention. The fishing pole 100 typically includes the line guides 102a, 102b, 102c, 102d, and 102e that are coupled to (or integrated with) the shaft 103 of the fishing pole 100. The number of line guides in the fishing pole 100 may vary. The line guides are aligned such that a fishing line (not shown in FIG. 1) can be disposed through the line guides and will be substantially parallel or adjacent to the shaft 103.

The rearward rod section of the fishing pole 100 would also typically include one or more pole grips 104. For example and without limitations, the fishing pole 100 includes a lower grip 104a and an upper grip 104b. In the discussion herein, the terms that refer to a direction (e.g., forward, forwardly, rearward, rearwardly left, forwardly right, and other directional terms) are used to denote a direction or position in reference to the fishing pole 100 when viewed from the perspective of a fisherman who is holding the fishing pole 100. Since the fisherman will typically hold the fishing pole 100 in front of herself/himself, the terms “forward” or “forwardly” would refer to elements near the tip of the fishing pole 100. The terms “rearward” or “rearwardly” would refer to elements near the handle (grips) of the fishing pole 100.

The fishing pole 100 can be, for example and without limitations, a split type pole which can be broken up (or split up) into two or more pieces for purposes of easy storage, easy transportation, and/or other convenience. However, the fishing pole 100 can also be another type of fishing pole.

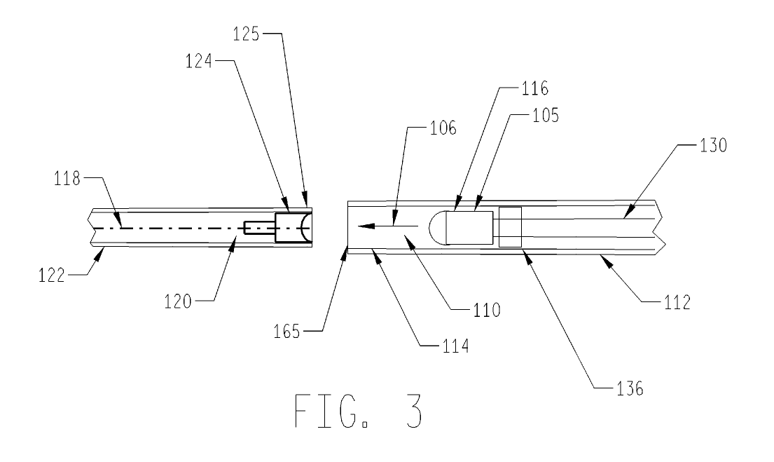

In an embodiment of the invention, the fishing pole 100 includes a light emitting diode (LED) 105 that emits light 106 (FIG. 3) when the LED 105 is electrically connected to a battery source 108. The LED 105 will not emit the light 106 when the LED 105 is electrically disconnected from the battery source 108. The battery source 108 is removably disposed within the fishing pole 100, as will be discussed below. A switch (or actuating mechanism) can be used to electrically connect and electrically disconnect the LED 105 from the battery source 108, as also will be discussed below. The battery source 108 can be, for example and without limitations, two double AA batteries 108a and 108b. However, other types of suitable portable power sources may be used as a battery source 108.

The LED 105 is securely disposed within the upper portion opening 110 of the rearward rod section 112 of the fishing pole 100. The opening 110 is within and surrounded by the rearward rod section 112. The rearward rod section 112 is in the rearward portion of the fishing pole 100.

The LED 105 can be, for example and without limitations, a watt LED, although the LED 105 can have other watt values. The LED 105 is configured to emit a light 106 (FIG. 3) of a selected color such as, for example and without limitations, green, red, or blue. Standard LEDs for use in an embodiment of the invention can be commercially obtained from various vendors.

The LED 105 can be securely attached to the inner wall 114 (FIG. 3) that surrounds the opening 110 of the rearward rod section 112. The LED 105 can be securely attached to the inner wall 114 by, for example and without limitations, use of a glue (or another type of adhesive) or by use of a suitable fastener.

In an embodiment of the invention, the LED 105 has a reflective base 116 that reflects the light 106 that is generated or emitted by the LED 105, so that the LED 105 achieves an increased efficiency in transmitting the light 106 toward an optical path 118 that is in optical communication with the LED 105. As known to those skilled in the art, an LED typically includes an emitting layer that emits the light and a base (or supporting member) on which the emitting layer is disposed upon. The optical path 118 can receive and then transmit the light 106 from the LED 105.

In an embodiment of the invention, the optical path 118 is disposed within the lower portion interior 120 (FIG. 3) of the forward rod section 122. In one embodiment, the optical path 118 is imbedded into this solid interior 120. The lower portion interior 120 is within and surrounded by the forward rod section 122. The forward rod section 122 is forwardly located in the fishing pole 100.

In an embodiment of the invention, the optical path 118 is, for example, a fiber optic line or fiber optic link. In this embodiment, the optical path 118 is connected to a fiber optic housing 124 that is disposed (or mounted) within the interior 120 at an end portion 125 of the forward rod section 122. In this embodiment, the optical path 118 extends from the fiber optic housing 124 to the fishing pole tip 126 of the fishing pole 100. The fiber optic housing 124 (fiber optic carriage 124) is configured to maintain the center of the optical path 118 with free mobility to allow fishing pole flexibility.

The optical path 118 is also partly disposed within a transparent tip portion 128 which is a light transparent material. The transparent tip portion 128 is integrated with the shaft 103, is forwardly disposed in the forward rod section 122 of the fishing pole 100, and is adjacent to (or near) the fishing pole tip 126. Therefore, the light 106 from the LED 105 will transmit along the optical path 118, and the light 106 along the optical path 118 is transparent and visible at the transparent tip portion 128. The light 106 will transmit at the optical path 118 and exit from the transparent tip portion 128. Additionally, the light 106 can also emit from the distal end of the optical path 118 at the tip 126 of the fishing pole 100.

In an embodiment of the invention, the transparent tip portion 128 is, for example and without limitations, a transparent fiberglass material that permits the light 106 along the optical path 118 to be visible and to be seen by the fisherman. As an example and without limitations, the transparent tip portion 128 is approximately one inch in length. However, the transparent tip portion 128 may be set to other length sizes.

In an embodiment of the invention, the fishing pole 100 also includes a conductor 130 (or conductors 130) that is coupled (or is electrically connected) between the LED 105 and a battery contact 132. The conductors 130 can be, for example and without limitations, wires or conductive traces. As a further example and without limitations, the conductors 130 are a pair of conductive wires that are electrically connected to the LED 105 and the battery contact 132.

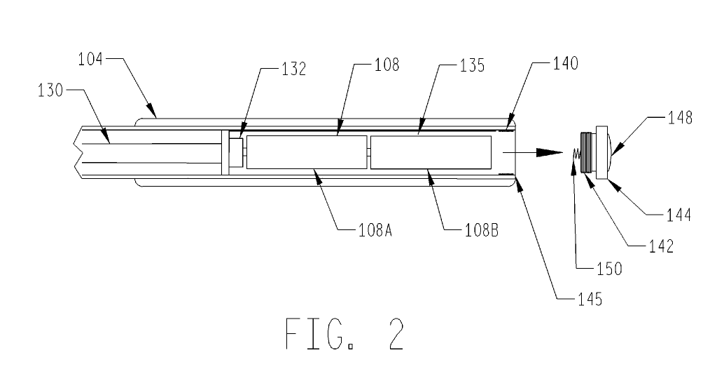

The battery contact 132 is within the battery compartment 135 which is disposed approximately in the rearward portion of fishing pole 100, and is coupled (or electrically connected) to the conductors 130. Typically, the battery compartment 135 is an opening within the fishing pole 100 and is near the pole grip 104 and bottom pole end 145 (FIG. 2). The battery compartment 135 is coupled to the shaft 103 of the fishing pole 100, or the battery compartment 135 is within the fishing pole 100. When the battery source 108 is removable inserted into the battery compartment 135, the battery source 108 is placed into electrical contact with the battery contact 134.

The conductors 130 are disposed within the internal opening 110 of the rearward rod section 112. In an embodiment of the invention, one or more wire stiffners 136 can be disposed at different locations within the opening 110 of the rearward rod section 112 and are coupled to the conductor 130. The wire stiffners 136 provide stability and prevent the movements of the conductors 130 within the opening 110.

Reference is now made to FIG. 1 and FIG. 2. FIG. 2 is a cross-sectional view of the battery compartment 135 in the illuminated fishing pole 100, in accordance with an embodiment of the invention. The battery compartment 135 includes internal threads 140 for threadedly receiving the exterior threads 142 of an end cap 144. Therefore, the end cap 144 is configured for removable attachment to fishing pole 100, and for removable attachment to the bottom pole portion 145.

The user would insert the battery source 108 into the battery compartment 135 and then would insert and removably secure the end cap 144 to the bottom pole portion 145 of the fishing pole 100 when the exterior threads 142 are removably secured to the internal threads 140. When the end cap 144 is removably secured to the fishing pole 100, the electrical circuit 146 (electrical path 146) (FIG. 1) is then coupled to the battery contact 132, battery source 108, and the actuator 148 in the end cap 144. The actuator 148 can be, for example and without limitations, a toggle switch, push-button switch, or another suitable type of actuator. The actuator 148 is removably connected to the bottom pole portion 145, and will electrically connect the battery source 108 to the LED 105. The actuator 148 also includes the spring 150 that is a conductive material. The actuator 148 is configured to connect the battery source 108 to the LED 105. When the user presses the actuator 148 in the “ON” position, the spring 150 comes into contact with the battery source 108, and as a result, the electrical circuit 146 is formed at the spring 150, battery source 108, battery contact 132, conductors 130, and LED 105. In the “ON” position, the power from the battery source 108 will permit the LED 105 to turn “ON” and to emit the light 106. The light 106 will then transmit along the optical path 118 and will be visible along the transparent tip portion 128 and fishing pole end 126. The light 106 allows improved visibility of the pole end 126, particularly during dark conditions. As a result, the fisherman can visually see the movement of the pole end 126 and see if a fish is tugging on the fishing line while he/she may be preoccupied with other tasks. When the pole end 126 is moving, then the fisherman is alerted of a possibility of a fish catch or a fish strike.

When the user presses the actuator 148 in the “OFF” position, the spring 150 is not in contact with the battery source 108, and as a result, the electrical circuit 146 is not formed at the spring 150, battery source 108, battery contact 132, conductors 130, and LED 105. In the “OFF” position, the power from the battery source 108 is not electrically transmitted to the LED 105, and as a result, the LED 105 is “OFF” and will not emit the light 106.

In another embodiment of the invention, the end cap 144 does not include the actuator 148 and spring 150. As a result, the end cap 144 does not function as a switch to turn the LED 105 into the “ON” state and “OFF” state. In this embodiment, the LED 105 is turned “ON” and “OFF” by use of a handle actuator 155 which can be, for example and without limitations, a toggle switch, a push-button switch, or another suitable actuator. The handle actuator 155 is typically disposed on a reel bracket 160 of a reel (not shown in FIG. 1) that can be removably secured (or permanently secured) to the rearward portion of the fishing pole 100. Typically, the handle actuator 155 is disposed adjacent to or near a grip 104 on the fishing pole 100. The handle actuator 155 is typically disposed on the fishing pole 100 and is typically disposed between the grips 104a and 104b. When the user presses the handle actuator 155 in the “ON” position, the handle actuator 155 will make the conductors 130 as a continuous electrical path, and as a result, the electrical circuit 146 is formed at the battery source 108, battery contact 132, conductors 130, and LED 105. In the “ON” position, the power from the battery source 108 will permit the LED 105 to turn “ON” and to emit the light 106, as similarly discussed above. The light 106 will then transmit along the optical path 118 and will be visible along the transparent tip portion 128 and fishing pole end 126.

When the user presses the handle actuator 155 in the “OFF” position, the handle actuator 155 will make the conductors 130 as a disconnected electrical path, and as a result, the electrical circuit 146 is not formed at the battery source 108, battery contact 132, conductors 130, and LED 105. In the “OFF” position, the power from the battery source 108 is not electrically transmitted to the LED 105, and as a result, the LED 105 is “OFF” and will not emit the light 106.

Various mechanisms of actuators for connecting and disconnecting the electrical paths such as conductors (e.g., conductive wires) and/or other electrical circuits are well known to those skilled in the art. Accordingly, for purposes of clarity, the details of the actuator 148 for permitting the actuator 148 to connect and disconnect the electrical signal transmission in the electrical circuit 146 (and the details of the actuator 155 for permitting the actuator 155 to connect and disconnect the electrical signal transmission in the conductor 130) are not discussed herein.

Reference is now made to FIG. 1 and FIG. 3. FIG. 3 is a cross-sectional view of the lower portion of the forward rod section 122 and the upper portion of the rearward rod section 112, in accordance with an embodiment of the invention. If the fishing pole 100 is a split type fishing pole, then the shaft 103 (FIG. 1) will include a rearward rod section 112 and a forward rod section 122. The sections 112 and 122 can be removably attached together and can be separated from each other. The end portion 125 of the forward rod section 122 can be removably attached to the end portion 165 of the rearward rod section 112.

As shown in FIG. 3, the optical path 118 is disposed within the forward rod section 122 and the LED 105 is disposed within the rearward rod section 112. The conductors 130 are also typically disposed within the rearward rod section 112.

In another embodiment of the invention, a method of assembling an illuminated fishing pole 100 (FIG. 1) includes: providing a light emitting diode 105 within a shaft 103 of the fishing pole 100, providing a battery compartment 135 coupled to the shaft 103 or within the fishing pole 100, providing a battery source 108 within the fishing pole 100, and providing an optical path 118 for transmitting the light 106 from the light emitting diode 105. The method can also include providing a transparent tip portion 128 in the shaft 103 of the fishing pole 100. The various components in the above method have been previously described above.

Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An illuminated fishing pole, comprising:
a shaft;
a light emitting diode (LED) disposed within the shaft;
a battery compartment coupled to the shaft; and
an optical path configured to transmit light from the LED.

2. The illuminated fishing pole of claim 1, further comprising:
a battery source that is removably inserted into the battery compartment.

3. The illuminated fishing pole of claim 1, further comprising:
an end cap configured for removable attachment to the fishing pole.

4. The illuminated fishing pole of claim 2, further comprising:
an actuator configured to electrically connect the battery source to the LED.

5. The illuminated fishing pole of claim 4, wherein the actuator is removably connected to the fishing pole.

6. The illuminated fishing pole of claim 4, wherein the actuator comprises a handle actuator.

7. The illuminated fishing pole of claim 1, wherein the optical path comprises a fiber optic line.

8. The illuminated fishing pole of claim 7, further comprising:
a fiber optic carriage coupled to the fiber optic line.

9. The illuminated fishing pole of claim 1, wherein the optical path is disposed in a forward rod section of the fishing pole.

10. The illuminated fishing pole of claim 1, further comprising:
a transparent tip portion.

11. The illuminated fishing pole of claim 10, wherein the transparent tip portion comprises a light transparent material.

12. The illuminated fishing pole of claim 10, wherein the transparent tip portion is adjacent to a tip of the fishing pole.

13. The illuminated fishing pole of claim 10, wherein the optical path is partly disposed within the transparent tip portion.

14. The illuminated fishing pole of claim 1, wherein the LED is disposed within an opening of the fishing pole.

15. The illuminated fishing pole of claim 1, wherein the LED is configured to emit a selected color.

16. The illuminated fishing pole of claim 1, further comprising:
a conductor coupled to the LED.

17. The illuminated fishing pole of claim 1, wherein the shaft comprises a forward rod section and a rearward rod section;
wherein the forward rod section and the rearward rod section are configured to be removably attached together and to be separated from each other.

18. The illuminated fishing pole of claim 17, wherein the optical path is disposed within the forward rod section and wherein the LED is disposed within the rearward rod section.

19. An illuminated fishing pole, comprising:
means for emitting a light within the fishing pole;
and
means for transmitting the light from the means for emitting the light.

20. A method of assembling an illuminated fishing pole, the method comprising:
providing a light emitting diode (LED) within the fishing pole;
providing a battery compartment within the fishing pole;
and
providing an optical path for transmitting light from the LED.
